(19) United States
(12) Patent Application Publication
(10) Pub. No.: US 2026/0225511 A1
(43) Pub. Date: Aug. 6, 2026

(54) VEHICLE SEAT WITH A SHELF AND TRANSPORTABLE STORAGE COMPARTMENT FOR A VEHICLE

(71) Applicant: Ford Global Technologies, LLC, Dearborn, MI (US)

(72) Inventors: Robert Engelmann, Köln (DE); Humayun Yousofzy, Solingen (DE); Joerg Stephan, Pulheim (DE)

(73) Assignee: Ford Global Technologies, LLC, Dearborn, MI (US)

(21) Appl. No.: 19/422,629

(22) Filed: Dec. 17, 2025

(30) Foreign Application Priority Data
Feb. 4, 2025 (DE) 102025103943.7

(51) Int. Cl. B60N 3/00; B60R 7/04

(52) U.S. Cl. CPC B60N 3/004; B60R 7/043

(57) ABSTRACT

A vehicle seat has a backrest, a headrest, and at least a shelf arranged on a rear side of the backrest to be foldable between a substantially vertical closed position and a substantially horizontal position of use. A first foldable shelf with a first axis of rotation is integrated into the rear side of the seat. A rectangular, foldable holding frame with a second axis of rotation arranged at a distance from the first axis of rotation is arranged to surround the first foldable shelf in its closed position in the rear side of the vehicle seat with the rectangular foldable holding frame. The first and second axes of rotation are arranged to be oriented substantially horizontally and in a plane of the rear side of the vehicle seat. At least one shelf is formed in the headrest and, in its position of use, exposes the storage compartment opening.

### CROSS-REFERENCE TO RELATED APPLICATION

This application claims foreign priority benefits under 35 U.S.C. § 119(a)-(d) to German Application No. 102025103943.7 filed February 4, 2025, which is hereby incorporated by reference in its entirety.

### FIELD OF THE DISCLOSURE

The present disclosure generally relates to a vehicle seat with a shelf and a transportable storage compartment for a vehicle.

### BACKGROUND OF THE DISCLOSURE

It is generally known to arrange, in vehicles, shelves and/or storage compartments, which are used for storing or receiving items in vehicles, such as a passenger car. Various arrangements of shelves and storage compartments in vehicles are known. It would be desirable to provide for a shelf and a transportable storage compartment in a vehicle that offers further storage features.

### SUMMARY OF THE DISCLOSURE

According to a first aspect of the present disclosure, a vehicle seat has a backrest, a headrest arranged with holders on an upper side of the backrest, and at least one shelf arranged in a region on a rear side of the vehicle seat. The at least one shelf is arranged to be foldable between a substantially vertical closed position, which is located in a plane of the rear side of the vehicle seat, and a substantially horizontal position of use. The at least one shelf comprises a first foldable shelf with a first axis of rotation and arranged to be integrated into the rear side of the vehicle seat. The first foldable shelf, in a closed position, is arranged on the vehicle seat to be oriented in the plane. A foldable holding frame with a second axis of rotation arranged at a distance from the first axis of rotation is arranged to be integrated into the rear side of the vehicle seat such that the foldable holding frame, in its closed position in the plane, completely surrounds the first foldable shelf in its closed position in the plane. The first and second axes of rotation are arranged to be oriented substantially horizontally and in the plane. The first axis of rotation is arranged below the second axis of rotation in the plane.

Embodiments of the first aspect of the present disclosure can include any one or a combination of the following features:

the at least one shelf comprises a second foldable shelf with a third axis of rotation arranged to be integrated into the rear side of the vehicle seat, wherein the third axis of rotation is arranged to be oriented horizontally, in the plane and below the first axis of rotation, and wherein the second foldable shelf is arranged to be foldable between a substantially vertical closed position and a substantially horizontal position of use;

the first foldable shelf is arranged to be pivotable downward, and that the foldable holding frame is arranged to be pivotable upward;

the foldable holding frame is designed such that its internal dimensions and its geometric internal shape correspond to external dimensions and a geometric external shape of the first foldable shelf;

the foldable holding frame and the first foldable shelf have a rectangular shape;

a container is arranged on the foldable holding frame;

the container comprises a flexible, net-like material;

the container is a bag comprising paper or plastic material;

the first and second axes of rotation are arranged to be oriented in a mutually parallel manner in the plane;

the plurality of holders for fastening a container are arranged on the foldable holding frame;

the container is arranged between the foldable holding frame in its position of use and the first foldable shelf in its position of use or the second foldable shelf in its position of use.

According to a second aspect of the present disclosure, a vehicle seat has a backrest, a headrest arranged with holders on an upper side of the backrest, and at least one shelf arranged in a region on a rear side of the vehicle seat. The at least one shelf is arranged to be foldable between a substantially vertical closed position, which is located in a plane of the rear side of the vehicle seat, and a substantially horizontal position of use. The at least one shelf is formed by a storage compartment door which, in a closed position, closes a storage compartment opening arranged in the headrest and, in its position of use, exposes the storage compartment opening. The storage compartment opening is arranged in the plane.

Embodiments of the second aspect of the present disclosure can include any one or a combination of the following features:

the at least one shelf comprises a first foldable shelf with a first axis of rotation and arranged to be integrated into the rear side of the vehicle seat;

the first foldable shelf, in a closed position, is arranged on the vehicle seat to be oriented in the plane, wherein a foldable holding frame with a second axis of rotation arranged at a distance from the first axis of rotation is arranged to be integrated into the rear side of the vehicle seat such that the foldable holding frame, in its closed position in the plane, completely surrounds the first foldable shelf in its closed position in the plane;

the first and second axes of rotation are arranged to be oriented substantially horizontally and in the plane;

the first axis of rotation is arranged below the second axis of rotation in the plane; and

the storage compartment door extends over the entire rear side of the headrest, wherein the storage compartment door is arranged to be pivotable downward, and that flexible side walls are arranged on the storage compartment door.

According to a third aspect of the present disclosure, a transportable storage compartment for a vehicle has a holding frame, foldable side walls and a base. The storage compartment has a space-saving, collapsed storage state and an open usage state providing storage volume. The storage compartment, in the storage state, is arranged in a trunk of the vehicle, forming a trunk shelf, and which, in the usage state, is arranged to be fixed in the trunk of the vehicle or on a rear seat bench of the vehicle.

Embodiments of the second aspect of the present disclosure can include any one or a combination of the following features:

storage compartment holders for fixing the transportable storage compartment on the rear seat bench are arranged on the rear seat bench, and fastening elements compatible with the storage compartment holders are arranged on the transportable storage compartment; and

the compatible fastening elements are arranged on the base of the transportable storage compartment.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear perspective view of a vehicle seat according to the present disclosure;

FIG. 2 is a rear perspective view of the vehicle seat with a first foldable shelf in its position of use;

FIG. 3 is a rear perspective view of the vehicle seat from FIG. 1, wherein the first foldable shelf and the foldable holding frame are each in the position of use;

FIG. 4 is a rear perspective view of the vehicle seat from FIG. 1, wherein the foldable holding frame and the second foldable shelf are each in the position of use;

FIG. 5 shows a headrest arranged on a backrest of a vehicle seat;

FIG. 6 is a side view of the headrest with a closed storage compartment door;

FIG. 7 is a side view of the headrest with an open storage compartment door;

FIG. 8 is an upper perspective view of a transportable storage compartment, arranged as a trunk cover, in its storage state;

FIG. 9 is an upper perspective view of the transportable storage compartment from FIG. 8, arranged in the trunk, in its usage state;

FIG. 10 is an upper perspective view of the transportable storage compartment from FIG. 8 arranged in the storage state behind a rear seat bench of a vehicle; and

FIG. 11 is an upper perspective view of the transportable storage compartment from FIG. 8 arranged in the usage state so as to be fixed on the rear seat bench of the vehicle.

In the different figures, like parts are always provided with the same reference signs, and for this reason they are, as a rule, only described once.

### DETAILED DESCRIPTION OF PREFERRED EMBODIMENTS

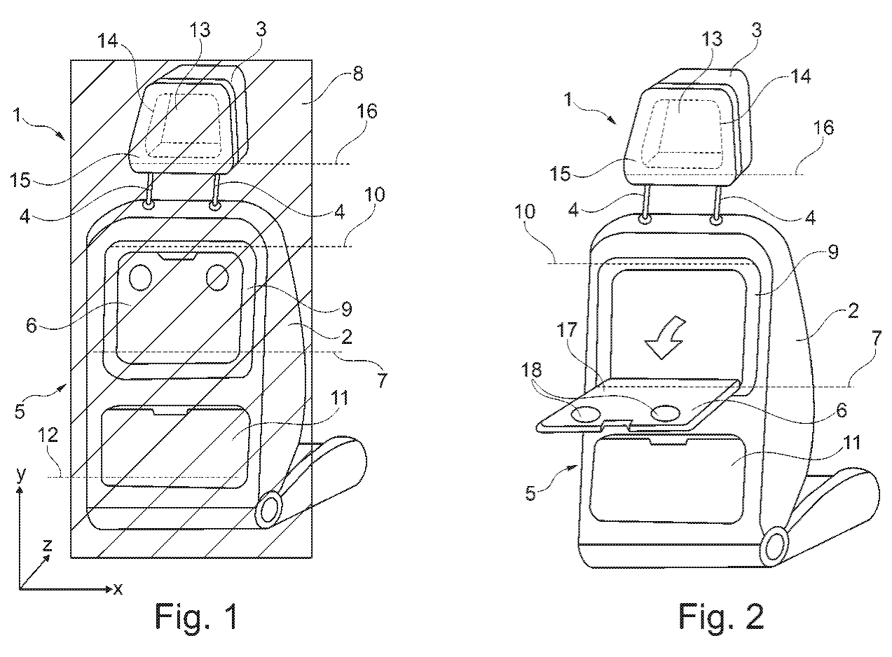

FIG. 1 shows a vehicle seat 1 according to the present disclosure. The vehicle seat 1 has a backrest 2 and a headrest 3. The headrest 3 is arranged with holders 4 on an upper side of the backrest 2 of the vehicle seat 1.

In the exemplary embodiment illustrated, a first foldable shelf 6 is arranged on a rear side 5 of the vehicle seat 1, preferably on its backrest 2, to be pivotable about a first axis 7 of rotation and integrated into the rear side 5 of the vehicle seat 1. This means that the first foldable shelf 6 is firmly connected to the backrest 2 on the rear side 5 of the vehicle seat 1, and that the first axis 7 of rotation of the first foldable shelf 6 is located in a plane 8 formed by the rear side 5 of the vehicle seat 1.

This notional plane 8 on the rear side 5 is illustrated by way of example in FIG. 1 as a hatched area, wherein the notional plane 8 is not limited only to the region of the backrest 2, but also encompasses the region of the rear side 21 of the headrest 3. In this respect, the notional plane 8 is arranged on the rear side 5 of the vehicle seat 1. The plane 8 extends along an X-direction and along a Z-direction. The plane 8 extends in a substantially vertically oriented manner. If the rear side 5 of the vehicle seat 1 extends with a deviation from the vertical, the notional plane 8 has the same deviation from the vertical. For the sake of simplicity, it is assumed in this description that the rear side 5 of the vehicle seat 1 has a near vertical orientation and that the plane 8 extends in a near vertical manner.

The first foldable shelf 6, in what is referred to as a closed position, is arranged on the vehicle seat 1 to be oriented in the plane 8 along the rear side 5 of the vehicle seat 1, as illustrated by way of example in FIG. 1. The first foldable shelf 6, which is arranged to be pivotable on the first axis 7 of rotation, can be pivoted or folded between the substantially vertical closed position and a substantially horizontal position of use, as illustrated in FIG. 2.

Moreover, a foldable holding frame 9, which is pivotable about a second axis 10 of rotation, is arranged to be integrated into the rear side 5 of the vehicle seat 1. This means that the foldable holding frame 9 is also firmly connected to the backrest 2 on the rear side 5 of the vehicle seat 1, and that the second axis 10 of rotation is likewise located in the plane 8. The second axis 10 of rotation is arranged at a distance from the first axis 7 of rotation and parallel thereto in said plane 8, wherein the first axis 7 of rotation is arranged below the second axis 10 of rotation in the plane 8.

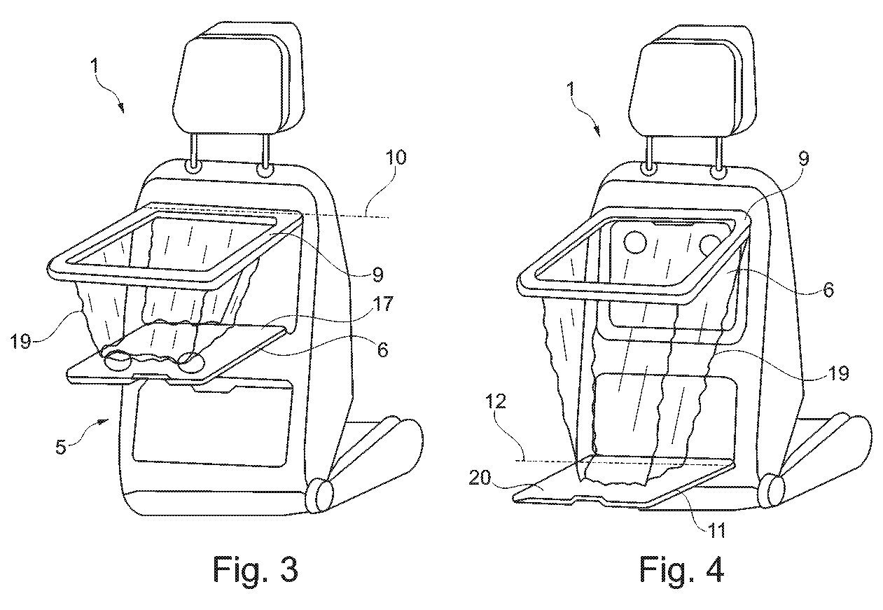

The foldable holding frame 9 also has a closed position, in which the foldable holding frame 9 is arranged to be oriented in the plane 8. The foldable holding frame 9, which is arranged to be pivotable on the second axis 10 of rotation, can be pivoted or folded between a substantially vertical closed position and a substantially horizontal position of use, as illustrated in FIGS. 3 and 4.

By way of example, the first foldable shelf 6, in its closed position, is completely surrounded by the foldable holding frame 9 when the latter is likewise in its closed position, as shown in FIG. 1. A grip cutout is also shown, which is arranged merely by way of example on the foldable shelf and which can be grasped to allow the first foldable shelf 6 to be actuated easily. The grip cutout may also be arranged on the foldable holding frame 9 so that the first foldable shelf 6 is easy to grip.

According to the exemplary embodiment in FIG. 1, the vehicle seat 1 further has a second foldable shelf 11, which is arranged in a region below the first foldable shelf 6 on the rear side 5 of the vehicle seat 1, in particular of the backrest 2. The second foldable shelf 11 is arranged to be pivotable about a third axis 12 of rotation, firmly connected to the backrest 2, and therefore likewise integrated into the rear side 5 of the vehicle seat 1. The third axis 12 of rotation is also arranged to be oriented horizontally in said plane 8, wherein the third axis 12 of rotation is located below the first axis 7 of rotation in the plane 8. The second foldable shelf 11 can also be pivoted between a substantially vertical closed position, in which it is arranged to be oriented in the plane 8, and a substantially horizontal position of use, which is illustrated in FIG. 4. A grip cutout is likewise shown.

The vehicle seat 1 has the headrest 3, in which a substantially hollow cuboid storage compartment 13 is arranged. A storage compartment opening 14 of the hollow cuboid storage compartment 13 is located in said plane 8 and is closed by a storage compartment door 15. In a closed state, the storage compartment door 15 is arranged to be fastened to the headrest 3 and likewise oriented in the plane 8. The storage compartment door 15 illustrated in the example in FIG. 1 is arranged to be pivotable about a fourth axis 16 of rotation and can therefore be opened or pivoted downward in the plane of the drawing. Since the hollow cuboid storage compartment 13 is closed in FIG. 1 by the storage compartment door 15, it is illustrated by a dashed line.

FIG. 2 shows the vehicle seat 1 with the first foldable shelf 6 in its position of use. The first foldable shelf 6 is arranged to be pivotable about the first axis 7 of rotation and can therefore be pivoted or folded out from its closed position located in said plane 8 into its substantially horizontal position of use, as indicated in FIG. 2 by an arrow. After being folded out in this manner, the first foldable shelf 6 in its position of use is arranged to be oriented projecting from the rear side 5 of the vehicle seat 1 and therefore also from the plane 8. In this position of use, items can be positioned on the first foldable shelf 6. In order to secure the items positioned on a first surface 17 of the first foldable shelf 6, such as beverage cups, in the event of the customary vibrations and jolts of a vehicle, two recesses 18 are arranged on the first surface 17 of the first foldable shelf 6. These recesses 18 may be designed as through-holes, which hold the example beverage cup in a suspended manner. The recesses 18 may, however, also be incorporated as depressions with a surrounding edge in the surface 17 in order to bear the example beverage cup in a standing position on the surface 17, wherein the edge surrounding the depression provides a necessary abutment.

In FIG. 3, the first foldable shelf 6 and the foldable holding frame 9 are each in their position of use. The foldable holding frame 9 is arranged to be pivotable about the second axis 10 of rotation and can therefore be pivoted or folded out from its closed position located in said plane 8 into its substantially horizontal position of use. After the first foldable shelf 6 and the foldable holding frame 9 have both been folded out into their respective positions of use, they are positioned to be oriented in a substantially horizontal and mutually parallel manner on the rear side 5 of the vehicle seat 1, as illustrated in FIG. 3. As illustrated by way of example, a container 19, which extends from the foldable holding frame 9 to the first surface 17 of the first foldable shelf 6, may be arranged in the foldable holding frame 9. In the exemplary embodiment according to FIG. 3, the container 19 is made of a flexible material, such as a net or a plastic material sack, and is illustrated in a merely indicative and transparent manner. When designed as a sack made of plastic material, the container 19 may, for example, receive waste produced during a journey with the vehicle. It is therefore possible for waste produced during the journey to be securely stored in the sack and disposed of appropriately, for example during a stop. For this purpose, the container 19, such as a sack, can be fastened in and removed from the foldable holding frame 9 easily. According to the exemplary embodiment in FIG. 4, the foldable holding frame 9 and the second foldable shelf 11 are each in their position of use.

The second foldable shelf 11 is arranged to be pivotable about the third axis 12 of rotation and can therefore be pivoted or folded out from its closed position located in the plane 8 into its substantially horizontal position of use, as illustrated in FIG. 4. After the foldable holding frame 9 and the second foldable shelf 11 have both been folded out into their respective positions of use, they are positioned to be oriented in a substantially horizontal and mutually parallel manner on the rear side 5 of the vehicle seat 1. As before, provision may be made to arrange, in the foldable holding frame 9, a container 19 which extends from the foldable holding frame 9 to the second surface 20 of the second foldable shelf 11. In the example in FIG. 4, the container 19 is made of a flexible material, such as a net or a plastic material sack, and is illustrated in a merely indicative and transparent manner. Otherwise, reference is made to the statements concerning the container 19 already made with regard to FIG. 3.

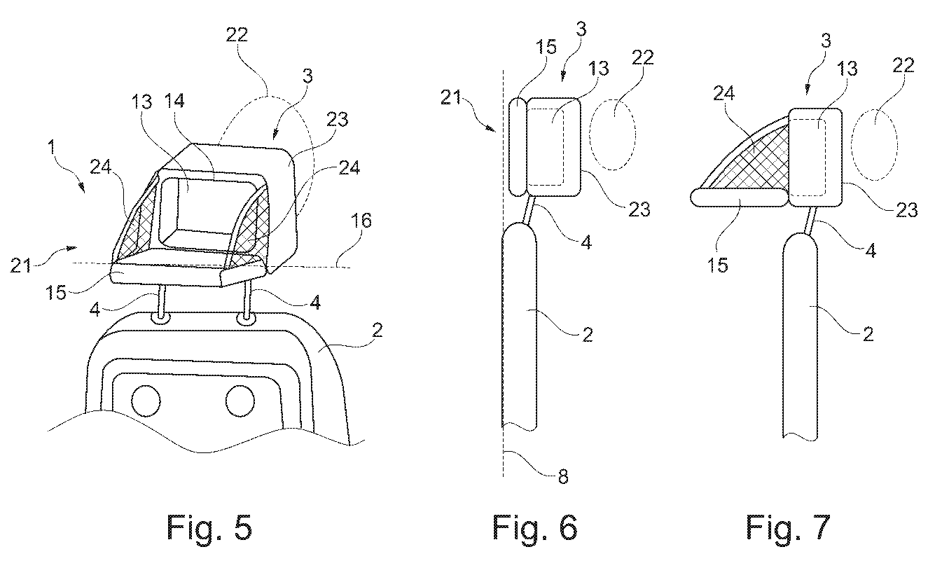

FIG. 5 shows the headrest 3 arranged on a backrest 2 of a vehicle seat 1. The headrest 3 is arranged on the upper side of the backrest 2 of the vehicle seat 1 with two holders 4. The hollow cuboid storage compartment 13 is arranged within the headrest 3. The substantially hollow cuboid storage compartment 13 has a storage compartment opening 14, which is located in the plane 8 on the rear side 5 of the vehicle seat 1.

The front side of the headrest 3 has a support region 23 designed with a shock-absorbing material for a head 22 of an occupant. This support region 23 may, for example, also be padded and/or provided with a covering. The storage compartment opening 14 is closed by use of a storage compartment door 15. This storage compartment door 15 on the rear side 21 of the headrest 3 is arranged on the headrest 3 to be pivotable about a fourth axis 16 of rotation. In particular, the fourth axis 16 of rotation is arranged in the lower region of the rear side 21 of the headrest 3, so that the storage compartment door 15 is folded out downward. To ensure that the storage compartment 13 is securely closed by the storage compartment door 15, the latter has a corresponding fixing device.

In a folded-out state of the storage compartment door 15, the latter forms a further shelf platform. In FIG. 5, the storage compartment door 15, which in its vertical closed position forms the rear side 21 of the headrest 3, extends over the entire rear side 21 of the headrest 3. Flexible side walls 24 are arranged between the sides of the storage compartment door 15 and the sides of the storage compartment 13 to secure items located in the hollow cuboid storage compartment 13 when the storage compartment door 15 is being opened or to secure items placed on the open storage compartment door 15. After the storage compartment door 15 has been fully opened, these each form a triangular flexible side wall 24 on the left and right of the storage compartment door 15 in the relevant plane of the drawing. Flexible side walls 24 of this type may be configured to be net-like and to include or consist of a textile or plastic material.

FIG. 6 shows a side view of the headrest 3 with a closed storage compartment door 15, whereas FIG. 7 depicts a side view of the headrest 3 with an open storage compartment door 15. For better understanding, the headrest 3 is illustrated in the side views with an open and a closed storage compartment door 15. FIG. 6 also shows the plane 8, which is located on the rear side 5 of the vehicle seat 1, in particular of the backrest 2. FIG. 7 shows one of the flexible side walls 24, which are located in the interior of the storage compartment 13 in the closed state of the storage compartment door 15.

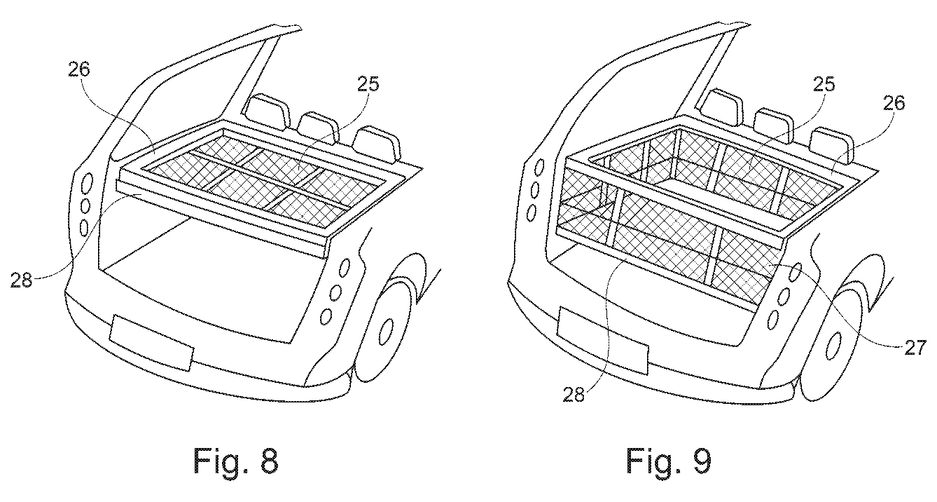

FIG. 8 shows a transportable storage compartment 25, arranged as a trunk cover, in its storage state. In FIG. 8, a portion of a vehicle is only selectively illustrated. In this portion, a trunk of a vehicle is shown only schematically, with the components necessary to describe the present disclosure. The transportable storage compartment 25 may be brought into a storage state or a usage state. While the transportable storage compartment 25 requires little space when collapsed in its storage state, the transportable storage compartment 25 in its open usage state provides a storage volume for receiving items.

FIG. 8 shows the transportable storage compartment 25, which has a holding frame 26, foldable side walls 27 and a base 28, in the storage state, in which it is arranged as a trunk cover in the trunk of the vehicle. Therefore, articles or items can be set down on the base 28 acting as the trunk cover, wherein the trunk of the vehicle, which is arranged under the transportable storage compartment 25 in the storage state, is unoccupied and can be used in the customary manner. In this position, the transportable storage compartment 25 is held in a positionally stable, preferably pivotable, manner by a rear side 5 of the backrest 2. At an end opposite thereto, the transportable storage compartment 25 may be connected via catches to a cable which is fastened at the other end to a rear hatch (not illustrated), so that this end of the transportable storage compartment 25 is lifted simultaneously when a rear hatch (not illustrated in the figures) is opened, in order to allow a greater degree of access to the trunk.

FIG. 9 shows the transportable storage compartment 25 arranged in the trunk in its usage state, in which the full storage space volume is provided. To transport items received in the transportable storage compartment 25, the transportable storage compartment 25 is arranged in the trunk in the usage position illustrated in the example in FIG. 9. In this case, the base 28 may be mounted to stand on the base of the trunk, wherein the transportable storage compartment 25 is adapted to the dimensions of the trunk, as shown in FIG. 9. It is also conceivable for the base 28 to be located at a distance from the trunk base when the transportable storage compartment 25 is in the usage position. The transportable storage compartment 25 is thus, in effect, suspended in the air, but this does not have a detrimental effect. Firstly, the base 28 is adapted in cooperation with the side walls 27 and the holding frame 26 to accommodate the expected maximum load. Secondly, the holding frame 26 is mounted in a stable manner on the backrest 2 and on bearing elements arranged laterally on the side walls of the trunk.

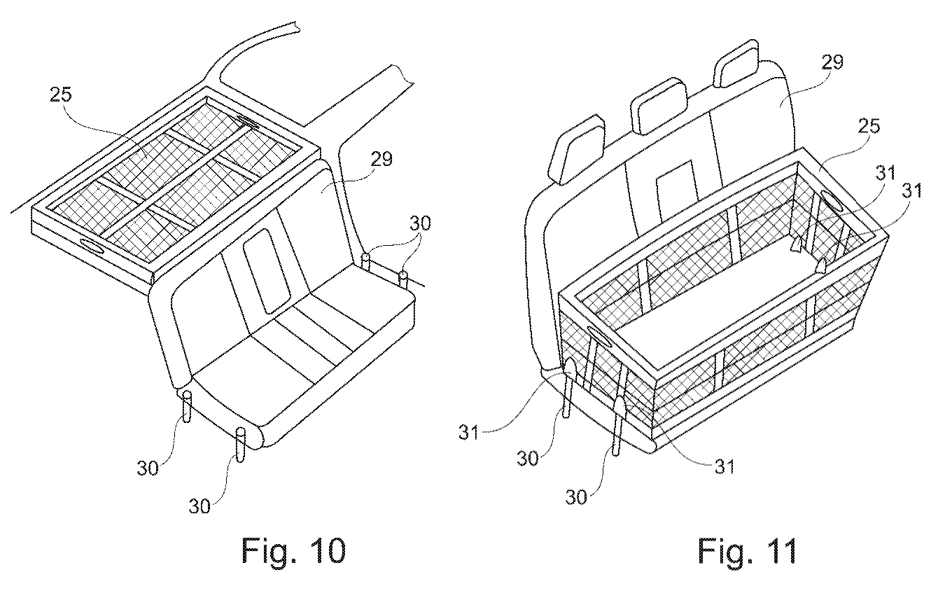

FIG. 10 shows the transportable storage compartment 25 arranged in the storage state behind a rear seat bench 29 of a vehicle. In FIG. 10, a portion of a vehicle is only selectively illustrated. In this portion, an indicated trunk of a vehicle and a rear seat bench 29 are only schematically shown, with the components necessary to describe the present disclosure. As already shown in FIG. 8, the transportable storage compartment 25, which has a holding frame 26, foldable side walls 27 and a base 28, is arranged, in the storage state, as a trunk cover in the trunk of the vehicle.

In order to be able to use the transportable storage compartment 25 securely in the region of a rear seat bench 29 of the vehicle, storage compartment holders 30 are arranged in the region of the rear seat bench 29. In the example in FIG. 10, two storage compartment holders 30 are arranged in each case on the respective sides of the rear seat bench 29.

FIG. 11 shows the storage compartment 25 arranged in the usage state to be fixed on the rear seat bench 29 of the vehicle. Again, only portions of a vehicle necessary for explanation are selectively illustrated in FIG. 11.

In FIG. 11, the transportable storage compartment 25 has been brought into its usage state offering storage space volume and arranged in a second usage position to be releasably fixed on the rear seat bench 29 of the vehicle. For this purpose, the storage compartment holders 30 are arranged on the rear seat bench 29 and fastening elements 31 compatible with the storage compartment holders 30 are provided on the transportable storage compartment 25. These fastening elements 31 are only indicatively illustrated in FIG. 11, as they are located within or on the base 28 of the transportable storage compartment 25. By using the storage compartment holders 30 and the compatible fastening elements 31, the transportable storage compartment 25 is fixed in position on the rear seat bench 29 in a positionally stable manner when the vehicle is driving. Instead of the separate storage compartment holders 30, it is, however, also possible to use seatbelt buckles, which are present in any case on the rear seat bench 29, as storage compartment holders 30, which cooperate with corresponding fastening elements 31 on the transportable storage compartment 25, in particular on its base 28. The fastening elements 31 could then be designed as corresponding seatbelt tongues.

The present disclosure presents a vehicle seat with at least one shelf which can be used flexibly, is easy to operate and is of robust design. In a further aspect, the present disclosure provides a transportable storage compartment, which is intended for a vehicle and which, in a collapsed storage state, requires little space and can be or is functionally arranged in the vehicle and which, in an open usage state providing storage volume, can be flexibly positioned in the vehicle.

In one aspect, a vehicle seat with a shelf is presented, wherein the vehicle seat has at least a backrest and a headrest, wherein the shelf is arranged in a region on a rear side of the vehicle seat, wherein the shelf is arranged to be foldable between a substantially vertical closed position, which is located in a plane of the rear side of the vehicle seat, and a substantially horizontal position of use, and wherein the headrest is arranged by means of holders on an upper side of the backrest of the vehicle seat.

According to the present disclosure, the shelf is designed as a first foldable shelf with a first axis of rotation, and arranged to be integrated into the rear side of the vehicle seat, wherein the first foldable shelf, in its closed position, is arranged on the vehicle seat to be oriented in the plane, wherein a preferably rectangular, foldable holding frame with a second axis of rotation arranged at a distance from the first axis of rotation is arranged to be integrated into the rear side of the vehicle seat in such a way that the holding frame, in its closed position in said plane of the vehicle seat, completely surrounds the first foldable shelf in its closed position in said plane, wherein the axes of rotation are arranged to be oriented substantially horizontally and in said plane, wherein the first axis of rotation is arranged below the second axis of rotation in said plane, wherein a hollow cuboid storage compartment with a storage compartment opening located in the plane is arranged in the headrest, and wherein a storage compartment door closing the storage compartment opening is arranged on the headrest.

It should be noted that the features and measures set out individually in the description may be combined with one another in any desired, technically meaningful manner and may indicate further configurations of the present disclosure. The description further characterizes and specifies the present disclosure, in particular in connection with the figures. The terms “first,” “second,” etc. in this description are only used for differentiation purposes. In particular, their use is not intended to imply any order or priority of the objects mentioned in connection with these terms.

The present disclosure provides a vehicle seat with a shelf for a motor vehicle. In this case, the term “motor vehicle” in the narrower sense refers to a road vehicle, i.e., a vehicle suitable and approved for road traffic with its own drive motor. The drive motor may be an internal combustion engine or an electric drive motor; a combination in the form of a hybrid drive is also conceivable. In particular, the motor vehicle may be a passenger car, a truck or a bus. The motor vehicle preferably has at least two axles, each with two wheels, although deviations herefrom are also conceivable. The motor vehicle may, at least temporarily, be controllable by a driver. It may also, however, be set up to drive, at least temporarily, in an autonomous manner, i.e., without being controlled by a driver. In the following, the motor vehicle is also referred to as "vehicle" for the sake of brevity.

A vehicle seat within the meaning of the present disclosure is a component of the interior of a vehicle and has at least a sitting surface and a backrest connected to the sitting surface. It is customary for the sitting surface of the vehicle seat to be arranged to be oriented substantially horizontally, while the backrest is arranged to be oriented substantially vertically. To increase comfort when a vehicle seat is used by vehicle occupants, the sitting surface and the backrest may be ergonomically adapted and have slight deviations from the horizontal or vertical orientation. Ergonomic adaptations of this type ensure optimum hold and support for occupants’ bodies, especially during relatively long periods of use on extended journeys with the vehicle. When configuring vehicle seats it is customary also to take into account other aspects. For example, seatbelts and airbags are arranged in or on vehicle seats. It is also known to arrange a headrest on an upper side of the backrest of the vehicle seat, wherein the headrest is arranged to be fastened to the backrest with corresponding holders.

As mentioned above, a first foldable shelf is provided, which is pivotable about a first axis of rotation. In one example, the first shelf has a rectangular shape. This first foldable shelf is arranged to be integrated into the rear side of the vehicle seat, which means that the first foldable shelf is firmly connected to the rear side of the vehicle seat, wherein the first axis of rotation of the first foldable shelf is located in a plane which is formed by the rear side of the vehicle seat, and also of the backrest. This also means that the first foldable shelf, in its closed position, is arranged on the vehicle seat to be oriented in said plane. Therefore the first foldable shelf, in its closed position, and the rear side of the vehicle seat form a common surface. This common surface corresponds to the above-mentioned plane on the rear side of the vehicle seat, and also of the backrest.

Since the first foldable shelf is arranged in the rear side of the vehicle seat to be pivotable about its first axis of rotation, the first foldable shelf can be pivoted from its substantially vertical closed position on the rear side of the vehicle seat into its substantially horizontal position of use, wherein the first foldable shelf is arranged to project in this manner from the rear side of the vehicle seat and therefore also from the plane. In this position of use, items can be positioned on the first foldable shelf. In order to secure the items positioned on the surface of the first foldable shelf in the event of the customary vibrations and jolts of a vehicle, depressions or recesses, such as for a beverage cup, are arranged on the surface of the first foldable shelf. Alternatively or additionally, a frame surrounding the first foldable shelf is arranged on the surface of the first foldable shelf.

To fix the first foldable shelf in its closed position or in its position of use, a hinge equipped with a latching device is provided in the region of the first axis of rotation. This latching device ensures pivotability on the one hand, and, on the other, the secure fixing of the first foldable shelf in the closed position and/or in the position of use. Other devices or features for correspondingly fixing the first foldable shelf in the respective position, i.e., the position of use or the closed position, also conceivable known. The first foldable shelf in its position of use is used in particular by occupants of a vehicle who are seated on a rear seat bench of the vehicle.

As likewise mentioned above, a foldable holding frame, which is pivotable about a second axis of rotation, is provided or arranged. In one example, the foldable holding frame has a rectangular shape. This foldable holding frame is likewise arranged to be integrated into the rear side of the vehicle seat, which means that the foldable holding frame is firmly connected to the rear side of the vehicle seat, and that the second axis of rotation of the foldable holding frame is also located in said plane, which is formed by the rear side of the vehicle seat, and also of the backrest.

The foldable holding frame is designed in such a way that its internal dimensions and its geometric internal shape correspond to external dimensions and a geometric external shape of the first foldable shelf. In this manner, it is possible for the foldable holding frame to be arranged on the vehicle seat, in particular on its backrest, to completely surround the first foldable shelf.

In its closed position, the foldable holding frame is arranged on the vehicle seat to be oriented in said plane on the rear side of the vehicle seat. Therefore, the first shelf in its closed position, the foldable holding frame in its closed position completely surrounding the first shelf, and the rear side of the vehicle seat form a common surface. This common surface corresponds to the above-mentioned plane on the rear side of the backrest.

Since the foldable holding frame is arranged in the rear side of the vehicle seat to be pivotable about its second axis of rotation, the foldable holding frame can be pivoted from its substantially vertical closed position on the rear side of the vehicle seat into its substantially horizontal position of use, wherein the foldable holding frame is arranged, in its position of use, to project in this manner from the rear side of the vehicle seat and therefore also from said plane. In this position of use, the foldable holding frame may receive a container, as described in greater detail in the following.

To fix the foldable holding frame in its closed position or in its position of use, a hinge equipped with a latching device is likewise provided in the region of the second axis of rotation. These latching device ensures pivotability on the one hand, and, on the other, the secure fixing of the foldable holding frame in its closed position and/or in its position of use. To lock the foldable holding frame in its respective position, i.e., in the respective closed position or position of use, other devices or features for correspondingly fixing the latter are conceivable. The foldable holding frame in its position of use is used in particular by occupants of a vehicle who are seated on a rear seat bench of the vehicle.

The first axis of rotation of the first foldable shelf and the second axis of rotation of the foldable holding frame are arranged to be oriented substantially horizontally in the plane on the rear side of the vehicle seat. Since the first axis of rotation is arranged below the second axis of rotation and correspondingly at a distance from the second axis of rotation, the first foldable shelf is pivoted downward from its closed position into its position of use, while the foldable holding frame is pivoted upward from its closed position into its position of use. For this purpose, the distance between the axes of rotation corresponds approximately to a height of the first foldable shelf, when the latter is in its vertical closed position. While the first foldable shelf and the foldable holding frame, in their respective closed positions, are arranged to be oriented substantially vertically in the plane of the rear side of the vehicle seat, and also of the backrest, the first foldable shelf and the foldable holding frame, in their respective positions of use, are arranged to be oriented in a mutually parallel manner and substantially horizontally thereto.

In a preferred configuration, a second foldable shelf with a third axis of rotation is arranged to be integrated into the rear side of the vehicle seat, wherein the third axis of rotation is arranged to be oriented horizontally, in the plane of the rear side of the vehicle seat, and also of the backrest, and below the first axis of rotation of the first foldable shelf, and wherein the second foldable shelf is arranged to be foldable between a substantially vertical closed position and a substantially horizontal position of use.

Thus, the vehicle seat may advantageously also have a second foldable shelf. This second foldable shelf is arranged to be pivotable about a third axis of rotation and, in a similar manner to the first foldable shelf, integrated into the rear side of the vehicle seat, which means that the second foldable shelf is firmly connected to the rear side of the vehicle seat, and that the third axis of rotation of the second foldable shelf is located in said plane, which is formed by the rear side of the vehicle seat and also of the backrest. Therefore, the first axis of rotation, the second axis of rotation and the third axis of rotation are located in this plane. The third axis of rotation of the second foldable shelf is also oriented horizontally, wherein the third axis of rotation is arranged below the first axis of rotation in said plane. Preferably, the second foldable shelf has a rectangular shape.

In its closed position, the second foldable shelf is likewise arranged on the vehicle seat to be oriented in said plane. Therefore the second foldable shelf, in its closed position, and the rear side of the vehicle seat form a common surface, which corresponds to the plane on the rear side of the vehicle seat, and also of the backrest.

Since the second foldable shelf is arranged in the rear side of the vehicle seat to be pivotable about its third axis of rotation, the second foldable shelf can be pivoted from its substantially vertical closed position on the rear side of the vehicle seat into its substantially horizontal position of use, wherein the second foldable shelf is arranged to project in this manner from the rear side of the vehicle seat and therefore also from the plane. In this position of use, items can be positioned on the second foldable shelf. In order to secure the items positioned on the second surface of the second foldable shelf in the event of the customary vibrations and jolts of a vehicle, depressions or recesses, such as for a beverage cup, are arranged on the second surface of the second foldable shelf. Alternatively or additionally, a frame surrounding the shelf is arranged on the surface of the second foldable shelf.

To fix the second foldable shelf in its closed position or in its position of use, a hinge equipped with a latching device is provided in the region of the third axis of rotation. This latching device ensures pivotability on the one hand, and, on the other, the secure fixing of the second foldable shelf in the closed position or in the position of use. Other devices or features for correspondingly fixing the second foldable shelf, as mentioned previously, are also conceivable. The second foldable shelf in its position of use is used in particular by occupants of a vehicle who are seated on a rear seat bench of the vehicle.

In a further preferred configuration, it is provided that the first foldable shelf and the second foldable shelf are arranged to be pivotable downward, and that the foldable holding frame is arranged to be pivotable upward. The first foldable shelf and the second foldable shelf are each folded out or moved from their respective closed position into their respective position of use by a pivot movement which is directed downward from above. During these pivot movements, the first foldable shelf is moved about its first axis of rotation and the second foldable shelf is moved about its third axis of rotation.

In contrast to the two foldable shelves, the foldable holding frame is pivoted upward in order to bring the foldable holding frame from the closed position into the position of use. During this pivot movement, the foldable holding frame is moved about its second axis of rotation. Downwardly or upwardly directed pivot movements of this type refer to a customary orientation of the vehicle seat and of the vehicle in which the vehicle seat is arranged.

In the respective positions of use, a vertical distance in the range of between 20 cm and 40 cm, in particular 30 cm, is established between the foldable holding frame and the first foldable shelf. A vertical distance in the range of between 50 cm and 70 cm, in particular 60 cm, is established between the foldable holding frame in its position of use and the second foldable shelf in its position of use.

It is expedient if the foldable holding frame is designed in such a way that its internal dimensions and its geometric internal shape correspond to external dimensions and a geometric external shape of the first foldable shelf. In an ideal configuration, the foldable holding frame and the first foldable shelf may have a rectangular shape, as already mentioned above. In order to design the foldable holding frame and the first foldable shelf to be stable and to have optimal dimensions, and to allow them, in their closed positions, to be arranged one within the other to be integrated into said plane of the rear side of the vehicle seat, and also of the backrest, the foldable holding frame and the first foldable shelf are adapted to each other. This adaptation includes both the dimensions and the shape. In this case, “arrange one within the other” means that the foldable holding frame in its closed position completely surrounds, in the manner of a frame, the first foldable shelf in its closed position.

For this reason, the geometric internal shape of the foldable holding frame is adapted, or is designed to correspond, to the geometric external shape of the first foldable shelf. In an example embodiment, the foldable shelf has a geometric external shape in the form of a rectangle, wherein the foldable holding frame then appropriately has a geometric internal shape in the form of a rectangle. In an alternative embodiment, the first foldable shelf may have a geometric external shape of an ellipse, wherein the geometric internal shape of the foldable holding frame in this embodiment would also be designed in the shape of an ellipse.

Moreover, the dimensions of the foldable holding frame are also adapted to the dimensions of the first foldable shelf. This means that internal measurements of the foldable holding frame are adapted to external measurements of the first foldable shelf. In this case, it is also provided that the internal measurements of the foldable holding frame, such as a width and a height, could be designed to be greater, by a predetermined gap measurement, than the external measurements, such as a width and a height, of the first foldable shelf. The internal measurements of the foldable holding frame and the external measurements of the first shelf may, however, also be identical. When the foldable holding frame and the first foldable shelf are arranged in the respective closed position in the plane of the rear side of the vehicle seat, and also of the backrest, a gap is established between the foldable holding frame and the first foldable shelf. This gap has a size corresponding to the gap measurement. In one embodiment, a rectangular foldable holding frame has internal measurements of 35 cm in width and 25 cm in height, wherein the rectangular first foldable shelf has external measurements of 35 cm in width and 25 cm in height. The foldable holding frame and the first shelf, via the relevant external and internal sides, are thus positioned virtually in contact with each other, wherein the gap is visible. The gap between the holding frame and the first shelf may preferably be 0.5 cm or less. In an ideal configuration, a grip cutout is arranged on the first shelf so that it is still possible to grip the latter despite the contact with the foldable holding frame in the closed position. It has been found to be particularly ideal for a container to be arranged on the holding frame.

A container, into which items may be introduced for storage, may be arranged on the, for example rectangular, foldable holding frame. In this case, it is provided that the container is fastened in the interior of the foldable holding frame by suitable fastening devices. Fastening in this manner also allows the container to be removed simply from the foldable holding frame. In one embodiment, the container may receive items such as a neck pillow, a blanket, scarves or gloves and store them securely when driving.

In addition, it may be provided that the container consists of a flexible, net-like material, or that the container is a bag consisting of paper or plastic material. In particular, it may be envisaged that the container is designed to be flexible. For example, the container may be a net which is arranged in the foldable holding frame. In one embodiment, the net is suspended in the foldable holding frame and in this manner forms the container for receiving various items. For this purpose, the fastening devices in the foldable holding frame are designed to suspend the net-shaped container.

Alternatively or additionally, it may be provided that the flexible container is designed in the form of bag consisting of paper or plastic material or as a sack. When designed as a sack made of plastic material, the container may, for example, also receive waste produced during a journey with the vehicle. In this manner, the waste produced can be stored securely during the journey and disposed of appropriately, for example during a stop, since the bag or sack can be removed easily from the foldable holding frame.

In a preferred configuration, the first axis of rotation, the second axis of rotation and the third axis of rotation are arranged to be oriented in a mutually parallel manner in the plane of the rear side of the vehicle seat, in particular of the backrest. Arranging the corresponding axes of rotation in this manner makes it possible to pivot as required and to reach positions of use which are characterized by a substantially horizontal orientation. This also ensures that the positions of use are oriented in a horizontal and mutually parallel manner.

It has proven to be particularly advantageous for a plurality of holders for fastening the container to be arranged on the foldable holding frame. A plurality of holders are arranged on or within the foldable holding frame to securely fasten the container, such as a net. These holders are designed to be adapted to the type of container to be received. For example, the holders are fastening devices such as hooks, in which a net-shaped container can easily be suspended. Alternatively or in addition to these hooks, further holders such as clamps may be arranged on the foldable holding frame in order to fasten, as a container, a bag consisting of paper to the foldable holding frame by clamping or trapping an upper edge of the bag. If both holders described above are arranged together on the foldable holding frame, either a net or a bag including or consisting of paper may be arranged as a container.

In a further advantageous configuration of the present disclosure, it is provided that the container is arranged between the foldable holding frame in its position of use and the first foldable shelf in its position of use or the second foldable shelf in its position of use. The container is fastened to the foldable holding frame or suspended in the foldable holding frame. To support the container arranged in the foldable holding frame, the first foldable shelf in its position of use may be used. Therefore, the base of the container arranged in the foldable holding frame is supported by the first foldable shelf. The container, such as a net, is therefore arranged to extend in the region between the foldable holding frame in its position of use and the first foldable shelf in its position of use.

Alternatively, the second foldable shelf in its position of use may be used to support the container arranged in the foldable holding frame. The container, such as a net, is therefore arranged to extend in the region between the foldable holding frame in its position of use and the second foldable shelf in its position of use. To make this possible, the first foldable shelf is arranged in its closed position.

In a further aspect of the present disclosure, a vehicle seat with a shelf is presented, wherein the vehicle seat has at least a backrest and a headrest, wherein the shelf is arranged in a region on a rear side of the vehicle seat, wherein the shelf is arranged to be foldable between a substantially vertical closed position, which is located in a plane of the rear side of the vehicle seat, and a substantially horizontal position of use, and wherein the headrest is arranged with holders on an upper side of the backrest of the vehicle seat. It is proposed that the at least one shelf is formed by a storage compartment door which, in a closed position, closes a storage compartment opening arranged in the headrest and, in its position of use, exposes the storage compartment opening, wherein the storage compartment opening is arranged in the plane.

The headrest has a front side which is formed as a support region for a head of an occupant seated on the vehicle seat on which the headrest is arranged. The headrest, which substantially has a cuboid external contour, has a hollow cuboid storage compartment surrounded by side walls. A region, which is to be viewed as the base surface of the hollow cuboid storage compartment, is arranged in the region of the front side of the headrest, wherein a supporting function of the headrest is not compromised. The hollow cuboid storage compartment has a storage compartment opening which is arranged opposite the base surface. In this manner, the storage compartment opening is arranged on the rear side of the headrest opposite the front side of the headrest. It is envisaged that the storage compartment opening is closed by use of the storage compartment door arranged on the headrest to be pivotable about a fourth axis of rotation.

In a further embodiment of the present disclosure, it may be provided that the storage compartment door extends over the entire rear side of the headrest, wherein the storage compartment door is arranged to be pivotable downward, and that flexible side walls are arranged on the storage compartment door.

As already mentioned above, the front side of the headrest has a support region, which is designed with a shock-absorbing material, for a head of an occupant. This region may, for example, also be padded and/or provided with a covering. The hollow cuboid storage compartment, which has the storage compartment opening, is arranged in the headrest, which substantially has a cuboid external contour. This storage compartment opening, which is arranged to be oriented opposite the front side of the headrest, is closed by use of the storage compartment door. This storage compartment door on the rear side of the headrest is arranged on the headrest to be pivotable or able to fold open about the fourth axis of rotation. In particular, the fourth axis of rotation is arranged in the lower region of the rear side of the headrest, so that the storage compartment door is folded out downward. Devices for securely closing the storage compartment door are arranged on the storage compartment door and on the hollow cuboid storage compartment.

The storage compartment door, which can be folded out downward in this manner, forms a further shelf platform. In order to maximize the storage volume of the hollow cuboid storage compartment in the headrest, the storage compartment door extends over the entire rear side of the headrest. In this manner, the storage compartment opening can be maximized. In its vertical closed position, the storage compartment door forms the rear side of the headrest.

To secure items located in the hollow cuboid storage compartment when the storage compartment door is opened or to secure items placed on the open storage compartment door, flexible side walls are arranged between the sides of the storage compartment door and the sides of the storage compartment. After the storage compartment door has been fully opened, these each form a triangular flexible side wall on the left and right of the storage compartment door. Flexible side walls of this type may be configured to be net-like and may consist of a textile or plastic material.

In a development of the present disclosure, flexible side walls of this type are also arranged on the first foldable shelf and/or on the second foldable shelf. The flexible side walls arranged on the right and left of the respective shelf prevent items located on the respective shelf from falling off laterally. Since the side walls are configured to be flexible, the foldable shelves and the storage compartment door on the headrest can be pivoted from their respective horizontal position into their respective vertical closed position without being obstructed by the flexible side walls.

In a further aspect, a storage compartment is presented, which is intended for a vehicle, is transportable, and has a holding frame, foldable side walls and a base, and which has a space-saving, collapsed storage state and an open usage state providing storage volume. According to the present disclosure, it is provided that, in the storage state, the transportable storage compartment is arranged in a trunk of the vehicle, forming a trunk shelf, and that, in the usage state, the transportable storage compartment is arranged to be fixed in the trunk of the vehicle or on a rear seat bench of the vehicle.

The transportable storage compartment has a holding frame which is arranged in the upper region of the transportable storage compartment and on which, for example, two or four openings such as grip openings are arranged. The transportable storage compartment can be transported easily by use of grip openings of this type. Moreover, the transportable storage compartment has foldable side walls and a base. The side walls arranged on four sides of the transportable storage compartment are arranged in each case between sides of the holding frame and associated sides of the base.

With the aid of the foldable side walls, the transportable storage compartment can be brought into a space-saving, collapsed storage state, in which the holding frame is arranged in the vicinity of the base and in which the transportable storage compartment has no significant storage space. In this storage state, the transportable storage compartment can be mounted in a space-saving manner or stowed in a vehicle.

By folding out the foldable side walls, the transportable storage compartment can also be brought into an open or folded-out state, in which the transportable storage compartment provides a maximum storage volume. This state is referred to as the usage state of the transportable storage compartment. In this usage state, items are introduced into the transportable storage compartment and transported with the transportable storage compartment.

According to the present disclosure, it is provided that the transportable storage compartment, when brought into its storage state, is arranged in a trunk of a vehicle. In this case, it may in particular be provided that the transportable storage compartment is arranged in the trunk of the vehicle in such a way that it forms a trunk shelf. In its storage state, the transportable storage compartment is arranged in a region behind a rear seat bench of the vehicle at a height corresponding approximately to the height of the backrest of the rear seat bench. It is customary to arrange trunk shelves in vehicles in this region behind the rear seat bench of a vehicle. In this storage state, the base of the transportable storage compartment forms a shelf which corresponds to the function of a trunk shelf. Functions of this type are both a protective screen for the contents of the trunk and a shelf platform for articles or items on the trunk shelf.

It is particularly advantageous that the transportable storage compartment can also, when arranged in the region of the trunk shelf, be transferred to the open usage state providing storage volume by folding open or unfolding the side walls. Alternatively, the transportable storage compartment in its usage state may also be arranged in any other desired position in the trunk of a vehicle, wherein storage compartment holders for fixing the transportable storage compartment in its position in the trunk are also provided in the trunk.

A further advantage of the transportable storage compartment according to the present disclosure is that the transportable storage compartment in the usage state is arranged to be fixed on a rear seat bench of the vehicle. Fixing of this type involves securing the position of the transportable storage compartment while the vehicle is driving and therefore increases positional stability when transporting the transportable storage compartment loaded with various items.

In a preferred configuration, it may be provided that storage compartment holders for fixing the transportable storage compartment are arranged on the rear seat bench, wherein fastening elements compatible with the storage compartment holders are arranged on the transportable storage compartment. The storage compartment holders and the compatible fastening elements can be released from one another at any time, but only when desired.

To fix or secure the position of the transportable storage compartment, it is provided that storage compartment holders for fixing the transportable storage compartment are arranged on the rear seat bench. In particular, storage compartment holders of this type for fixing the transportable storage compartment can be folded open or extended. If a transportable storage compartment is not arranged on the rear seat bench, the storage compartment holders can be folded in or retracted and in this manner do not hinder the occupants of the vehicle when using the rear seat bench.

Fastening elements compatible with the storage compartment holders are arranged on the transportable storage compartment. To secure its position, the transportable storage compartment is arranged on the rear seat bench in such a way that the storage compartment holders cooperate with the compatible fastening elements and in this manner fix the transportable storage compartment.

In a preferred configuration, the fastening elements are arranged on the base of the transportable storage compartment. This makes it simpler to fix the transportable storage compartment or connect the compatible fastening elements with the storage compartment holders on the rear seat bench.

The storage compartment holders could be designed in the manner of a seatbelt buckle, wherein the fastening elements compatible therewith can, as seatbelt tongues, engage in a latching manner therein. Seatbelt buckles of this type are already arranged on the rear seat bench for each occupant. It is within the scope of the present disclosure to use the former to fix the storage compartment container on the rear seat bench and, for this purpose, seatbelt tongues corresponding thereto may be provided as fastening elements. It may indeed be sufficient to use only the seatbelt buckles of the two outer seats of the rear seat bench, wherein then also only two fastening elements configured as corresponding seatbelt tongues would be sufficient for mounting in a securely positioned manner. This represents a simple fastening option, wherein elements of the vehicle interior which are present in any case, that is to say the seatbelt buckles, are provided with a further function. However, other configurations are also conceivable. For example, four separate storage compartment holders may be arranged on the rear seat bench and four compatible fastening elements may be arranged on the transportable storage compartment. In this respect, storage compartment holders and fastening elements compatible therewith could alternatively and/or additionally be designed as loops, eyelets or rings, bayonets and/or hook-and-loop strips.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seat comprising:
a backrest;
a headrest arranged with holders on an upper side of the backrest; and
at least one shelf arranged in a region on a rear side of the vehicle seat, wherein the at least one shelf is arranged to be foldable between a substantially vertical closed position, which is located in a plane of the rear side of the vehicle seat, and a substantially horizontal position of use, wherein the at least one shelf comprises a first foldable shelf with a first axis of rotation and arranged to be integrated into the rear side of the vehicle seat, wherein the first foldable shelf, in a closed position, is arranged on the vehicle seat to be oriented in the plane, wherein a foldable holding frame with a second axis of rotation arranged at a distance from the first axis of rotation is arranged to be integrated into the rear side of the vehicle seat such that the foldable holding frame, in its closed position in the plane, completely surrounds the first foldable shelf in its closed position in the plane, wherein the first and second axes of rotation are arranged to be oriented substantially horizontally and in the plane, and wherein the first axis of rotation is arranged below the second axis of rotation in the plane.

2. The vehicle seat according to claim 1, wherein the at least one shelf comprises a second foldable shelf with a third axis of rotation arranged to be integrated into the rear side of the vehicle seat, wherein the third axis of rotation is arranged to be oriented horizontally, in the plane and below the first axis of rotation, and wherein the second foldable shelf is arranged to be foldable between a substantially vertical closed position and a substantially horizontal position of use.

3. The vehicle seat according to claim 2, wherein the first foldable shelf is arranged to be pivotable downward, and that the foldable holding frame is arranged to be pivotable upward.

4. The vehicle seat according to claim 1, wherein the foldable holding frame is designed such that its internal dimensions and its geometric internal shape correspond to external dimensions and a geometric external shape of the first foldable shelf.

5. The vehicle seat according to claim 1, wherein the foldable holding frame and the first foldable shelf have a rectangular shape.

6. The vehicle seat according to claim 1, further comprising a container arranged on the foldable holding frame.

7. The vehicle seat according to claim 6, wherein the container comprises a flexible, net-like material.

8. The vehicle seat according to claim 6, wherein the container is a bag comprising paper or plastic material.

9. The vehicle seat according to claim 1, wherein the first and second axes of rotation are arranged to be oriented in a mutually parallel manner in the plane.

10. The vehicle seat according to claim 2, further comprising a plurality of holders for fastening a container are arranged on the foldable holding frame.

11. The vehicle seat according to claim 10, wherein the container is arranged between the foldable holding frame in its position of use and the first foldable shelf in its position of use or the second foldable shelf in its position of use.

12. A vehicle seat comprising:
a backrest;
a headrest arranged with holders on an upper side of the backrest; and
at least one shelf arranged in a region on a rear side of the vehicle seat, wherein the at least one shelf is arranged to be foldable between a substantially vertical closed position, which is located in a plane of the rear side of the vehicle seat, and a substantially horizontal position of use, wherein the at least one shelf is formed by a storage compartment door which, in a closed position, closes a storage compartment opening arranged in the headrest and, in its position of use, exposes the storage compartment opening, and wherein the storage compartment opening is arranged in the plane.

13. The vehicle seat according to claim 12, wherein the at least one shelf comprises a first foldable shelf with a first axis of rotation and arranged to be integrated into the rear side of the vehicle seat, wherein the first foldable shelf, in a closed position, is arranged on the vehicle seat to be oriented in the plane, wherein a foldable holding frame with a second axis of rotation arranged at a distance from the first axis of rotation is arranged to be integrated into the rear side of the vehicle seat such that the foldable holding frame, in its closed position in the plane, completely surrounds the first foldable shelf in its closed position in the plane, wherein the first and second axes of rotation are arranged to be oriented substantially horizontally and in the plane, and wherein the first axis of rotation is arranged below the second axis of rotation in the plane.

14. The vehicle seat according to claim 12, wherein the storage compartment door extends over the entire rear side of the headrest, wherein the storage compartment door is arranged to be pivotable downward, and that flexible side walls are arranged on the storage compartment door.

15. A transportable storage compartment for a vehicle, the transportable storage compartment comprising:
a holding frame;
foldable side walls; and
a base, wherein the storage compartment has a space-saving, collapsed storage state and an open usage state providing storage volume, and wherein the storage compartment, in the storage state, is arranged in a trunk of the vehicle, forming a trunk shelf, and which, in the usage state, is arranged to be fixed in the trunk of the vehicle or on a rear seat bench of the vehicle.

16. The transportable storage compartment according to claim 15, further comprising storage compartment holders for fixing the transportable storage compartment on the rear seat bench arranged on the rear seat bench, and fastening elements compatible with the storage compartment holders arranged on the transportable storage compartment.

17. The transportable storage compartment according to claim 16, wherein the compatible fastening elements are arranged on the base of the transportable storage compartment.
